(19) United States
(12) Patent Application Publication
(10) Pub. No.: US 2022/0147049 A1
(43) Pub. Date: May 12, 2022

(54) POINT CLOUD-BASED MAP CALIBRATION METHOD AND SYSTEM, ROBOT AND CLOUD PLATFORM

(71) Applicant: CLOUDMINDS ROBOTICS CO., LTD., Shanghai (CN)

(72) Inventors: Xiangyu MENG, Shanghai (CN); Shikui MA, Shanghai (CN); Wenfeng DONG, Shanghai (CN)

(73) Assignee: CLOUDMINDS ROBOTICS CO., LTD., Shanghai (CN)

(21) Appl. No.: 17/563,792

(22) Filed: Dec. 28, 2021

Related U.S. Application Data
(63) Continuation of application No. PCT/CN2021/122363, filed on Sep. 30, 2021.

(30) Foreign Application Priority Data
Nov. 9, 2020 (CN) 2020112375329

(51) Int. Cl. G05D 1/02; G06V 20/64; G06V 10/94

(52) U.S. Cl. CPC G05D 1/0214; G06V 10/95; G06V 20/64

(57) ABSTRACT

The present disclosure discloses a point cloud-based map calibration method and system, a robot and a cloud platform. The method is applied to a cloud platform communicatively connected to a designated robot, and includes: obtaining environmental acquisition information from the designated robot; performing three-dimensional point cloud reconstruction on the environmental acquisition information, performing obstacle recognition on a three-dimensional point cloud reconstruction result, and obtaining an obstacle recognition result including obstacle information and confidence information corresponding to the obstacle information; and when it is determined that the confidence information satisfies a first preset index, sending map calibration information corresponding to the obstacle information to the designated robot, so that the designated robot calibrates map information according to the map calibration information.

### CROSS-REFERENCE TO RELATED APPLICATIONS

This application is a continuation of International Application No. PCT/CN2021/122363, filed on Sep. 30, 2021, the disclosure of which is hereby incorporated by reference in its entirety.

### FIELD

The present disclosure relates to the technical field of point clouds, and more particularly to a point cloud-based map calibration method and system, a robot and a cloud platform.

### BACKGROUND

At present, a digital twin virtual reality combining robot has the functions of planning routes, executing operations, etc. In the implementation process of a digital twin virtual reality combining robot control system, since objects in a real environment may change at any time, pre-made digital map information of the robot cannot reflect a current real environment in real time, such as dynamic environmental obstacles (tables and chairs, people, etc.) and environmental changes (room furniture layout changes, etc.). As a result, the robot may easily collide with obstacles during navigation, grabbing and other operations, the success rate of navigation or grabbing is reduced, and a risk factor of robot action is increased.

### SUMMARY

Embodiments of the present disclosure provide a point cloud-based map calibration method and system, a robot and a cloud platform, capable of calibrating map information of a robot through three-dimensional point cloud reconstruction.

An aspect of the embodiments of the present disclosure provides a point cloud-based map calibration method. The method is applied to a cloud platform communicatively connected to a designated robot. The method includes: obtaining environmental acquisition information from the designated robot; performing three-dimensional point cloud reconstruction on the environmental acquisition information, performing obstacle recognition on a three-dimensional point cloud reconstruction result, and obtaining an obstacle recognition result including obstacle information and confidence information corresponding to the obstacle information; and when it is determined that the confidence information satisfies a first preset index, sending map calibration information corresponding to the obstacle information to the designated robot, so that the designated robot calibrates map information according to the map calibration information.

In an embodiment, the cloud platform is also communicatively connected to a supervisor. The method further includes: when it is determined that the confidence information does not satisfy a first preset index, sending an obstacle confirmation request to the supervisor, so as to request the supervisor to determine whether obstacle information corresponding to the confidence information satisfies a second preset index; receiving obstacle feedback information from the supervisor, the obstacle feedback information carrying a determination result corresponding to the obstacle information; and when the determination result is that the obstacle information corresponding to the confidence information satisfies the second preset index, sending map calibration information corresponding to the obstacle information to the designated robot, so that the designated robot calibrates map information according to the map calibration information.

In an embodiment, after sending map calibration information corresponding to the obstacle information to the designated robot, the method further includes: receiving instruction planning information from the designated robot, the instruction planning information carrying a first planned path; sending a three-dimensional point cloud reconstruction result and environmental acquisition information corresponding to the first planned path to a supervisor, so that the supervisor judges whether the first planned path complies with a third preset index based on the three-dimensional point cloud reconstruction result and the environmental acquisition information, so as to obtain a judgment result; and receiving the judgment result from the supervisor, and sending planning feedback information to the designated robot based on the judgment result, so that the designated robot determines a second planned path based on the planning feedback information, the first planned path being the same as or different from the second planned path.

Another aspect of the embodiments of the present disclosure provides a point cloud-based map calibration method. The method is applied to a robot communicatively connected to a cloud platform. The method includes: sending environmental acquisition information to the cloud platform, so that the cloud platform performs three-dimensional point cloud reconstruction on the environmental acquisition information, performs obstacle recognition on a three-dimensional point cloud reconstruction result, and obtains an obstacle recognition result including obstacle information and confidence information corresponding to the obstacle information; receiving map calibration information from the cloud platform, the map calibration information corresponding to the obstacle information in which the confidence information satisfies a first preset index; and calibrating map information according to the map calibration information to obtain calibrated map information.

In an embodiment, before sending environmental acquisition information to the cloud platform, the method further includes: obtaining a planning instruction for instructing to perform path planning on the map information according to a designated operation; and acquiring information based on the planning instruction to obtain environmental acquisition information.

In an embodiment, after calibrating map information according to the map calibration information, the method further includes: performing path planning on the designated operation on the calibrated map information to obtain a first planned path; sending the first planned path to the cloud platform so as to instruct the cloud platform to judge whether the first planned path complies with a third preset index through a supervisor, so as to obtain a judgment result; and receiving planning feedback information corresponding to the judgment result from the cloud platform, and determining a second planned path based on the planning feedback information, the first planned path being the same as or different from the second planned path.

Another aspect of the present disclosure provides a cloud platform communicatively connected to a designated robot. The cloud platform includes: a first obtaining module, configured to obtain environmental acquisition information from the designated robot; a reconstruction module, configured to perform three-dimensional point cloud reconstruction on the environmental acquisition information, perform obstacle recognition on a three-dimensional point cloud reconstruction result, and obtain an obstacle recognition result including obstacle information and confidence information corresponding to the obstacle information; and a first sending module, configured to send, when it is determined that the confidence information satisfies a first preset index, map calibration information corresponding to the obstacle information to the designated robot, so that the designated robot calibrates map information according to the map calibration information.

In an embodiment, the cloud platform is also communicatively connected to a supervisor, and further includes a first receiving module. The first sending module is further configured to send, when it is determined that the confidence information does not satisfy a first preset index, an obstacle confirmation request to the supervisor, so as to request the supervisor to determine whether obstacle information corresponding to the confidence information satisfies a second preset index. The first receiving module is configured to receive obstacle feedback information from the supervisor, the obstacle feedback information carrying a determination result corresponding to the obstacle information. The first sending module is further configured to send, when the determination result is that the obstacle information corresponding to the confidence information satisfies the second preset index, map calibration information corresponding to the obstacle information to the designated robot, so that the designated robot calibrates map information according to the map calibration information.

In an embodiment, the first receiving module is further configured to receive instruction planning information from the designated robot, the instruction planning information carrying a first planned path. The first sending module is further configured to send a three-dimensional point cloud reconstruction result and environmental acquisition information corresponding to the first planned path to a supervisor, so that the supervisor judges whether the first planned path complies with a third preset index based on the three-dimensional point cloud reconstruction result and the environmental acquisition information, so as to obtain a judgment result. The first receiving module is further configured to receive the judgment result from the supervisor, and send planning feedback information to the designated robot based on the judgment result, so that the designated robot determines a second planned path based on the planning feedback information. The first planned path is the same as or different from the second planned path.

Another aspect of the embodiments of the present disclosure provides a robot communicatively connected to a cloud platform. The robot includes: a second sending module, configured to send environmental acquisition information to the cloud platform, so that the cloud platform performs three-dimensional point cloud reconstruction on the environmental acquisition information, performs obstacle recognition on a three-dimensional point cloud reconstruction result, and obtains an obstacle recognition result including obstacle information and confidence information corresponding to the obstacle information; a second receiving module, configured to receive map calibration information from the cloud platform, the map calibration information corresponding to the obstacle information in which the confidence information satisfies a first preset index; and a calibration module, configured to calibrate map information according to the map calibration information to obtain calibrated map information.

In an embodiment, the robot further includes: a second obtaining module, configured to obtain a planning instruction for instructing to perform path planning on the map information according to a designated operation; and an acquisition module, configured to acquire information based on the planning instruction to obtain environmental acquisition information.

In an embodiment, the robot further includes: a planning module, configured to perform path planning on the designated operation on the calibrated map information to obtain a first planned path. The second sending module is further configured to send the first planned path to the cloud platform so as to instruct the cloud platform to judge whether the first planned path complies with a third preset index through a supervisor, so as to obtain a judgment result. The second receiving module is further configured to receive planning feedback information corresponding to the judgment result from the cloud platform, and determines a second planned path based on the planning feedback information. The first planned path is the same as or different from the second planned path.

Another aspect of the embodiments of the present disclosure provides a point cloud-based map calibration system including a cloud platform and a designated robot. The cloud platform is communicatively connected to the designated robot. The cloud platform includes: a first obtaining module, configured to obtain environmental acquisition information from the designated robot; a reconstruction module, configured to perform three-dimensional point cloud reconstruction on the environmental acquisition information, perform obstacle recognition on a three-dimensional point cloud reconstruction result, and obtain an obstacle recognition result including obstacle information and confidence information corresponding to the obstacle information; and a first sending module, configured to send, when it is determined that the confidence information satisfies a first preset index, map calibration information corresponding to the obstacle information to the designated robot, so that the designated robot calibrates map information according to the map calibration information.

The calibration method provided by the embodiments of the present disclosure is used for obtaining obstacle information and corresponding confidence information in a real environment according to three-dimensional point cloud reconstruction, and calibrating map information of a robot according to map calibration information corresponding to the obstacle information, so that the robot can better integrate and calibrate obstacles in the real environment and the map information, thereby avoiding colliding with the obstacles in the real environment when the robot navigates or performs other operations according to the map information, reducing a risk factor of robot action and improving the safety of the robot action.

### BRIEF DESCRIPTION OF THE DRAWINGS

The foregoing and other objects, features and advantages of exemplary embodiments of the present disclosure will become readily apparent from the following detailed description when read with reference to the accompanying drawings. Several embodiments of the present disclosure are illustrated by way of example, and not by way of limitation, in the accompanying drawings, where:

In the drawings, the same or corresponding reference numerals designate the same or corresponding parts.

FIG. 1 is a schematic diagram of an implementation flow of a point cloud-based map calibration method according to an embodiment of the present disclosure;

FIG. 2 is a schematic diagram of an implementation flow of judging obstacle information by a supervisor in a point cloud-based map calibration method according to an embodiment of the present disclosure;

FIG. 3 is a schematic diagram of an implementation flow of calibrating a planned path in a point cloud-based map calibration method according to an embodiment of the present disclosure;

FIG. 4 is a schematic diagram of a scene implementation flow of a point cloud-based map calibration method according to an embodiment of the present disclosure;

FIG. 5 is a schematic scene diagram of a point cloud-based map calibration method according to an embodiment of the present disclosure;

FIG. 6 is a diagram of a scene effect after executing a point cloud-based map calibration method according to an embodiment of the present disclosure; and

FIG. 7 is a schematic diagram of an implementation module of a cloud platform according to an embodiment of the present disclosure.

### DETAILED DESCRIPTION OF EXAMPLE EMBODIMENTS

In order that the objects, features, and advantages of the present disclosure may be more fully apparent and appreciated, the technical solutions in the embodiments of the present disclosure will be clearly and completely described below in combination with the drawings in the embodiments of the present disclosure. Obviously, the described embodiments are merely a part of the embodiments of the present disclosure and not all the embodiments. Based on the embodiments in the present disclosure, all other embodiments obtained by a person skilled in the art without making any inventive effort fall within the protection scope of the present disclosure.

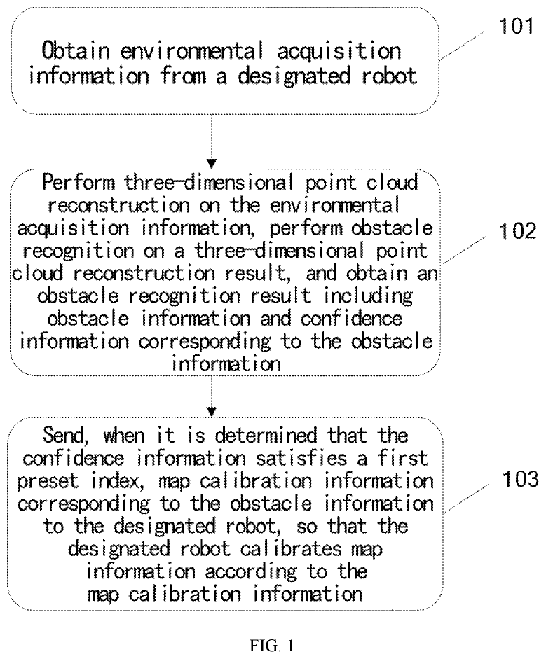

FIG. 1 is a schematic diagram of an implementation flow of a point cloud-based map calibration method according to an embodiment of the present disclosure.

Referring to FIG. 1, an aspect of the embodiments of the present disclosure provides a point cloud-based map calibration method. The method is applied to a cloud platform. The cloud platform is communicatively connected to a designated robot. The method includes: step 101, obtaining environmental acquisition information from the designated robot; step 102, performing three-dimensional point cloud reconstruction on the environmental acquisition information, performing obstacle recognition on a three-dimensional point cloud reconstruction result, and obtaining an obstacle recognition result including obstacle information and confidence information corresponding to the obstacle information; and step 103, when it is determined that the confidence information satisfies a first preset index, sending map calibration information corresponding to the obstacle information to the designated robot, so that the designated robot calibrates map information according to the map calibration information.

The calibration method provided by the embodiments of the present disclosure is used for obtaining obstacle information and corresponding confidence information in a real environment according to three-dimensional point cloud reconstruction, and calibrating map information of a robot according to map calibration information corresponding to the obstacle information when the confidence information satisfies a first preset index, so that the robot may better integrate and calibrate obstacles in the real environment and the map information, thereby avoiding colliding with the obstacles in the real environment when the robot navigates or performs other operations according to the map information, reducing a risk factor of robot action and improving the safety of the robot action.

Specifically, in step 101 according to the embodiments of the present disclosure, the cloud platform may establish a communication connection with a plurality of robots, and the cloud platform records an identity corresponding to each robot. The identity of each robot has uniqueness, so that the cloud platform may recognize and distinguish the plurality of robots. The cloud platform obtains environmental acquisition information from a designated robot through communication transmission. The designated robot is one of the plurality of robots in communication connection with the cloud platform. The environmental acquisition information may be used for characterizing that the designated robot acquires information corresponding to a real environment by a radar and/or a camera, such as a photograph or a radar image corresponding to the real environment.

In step 102 according to the embodiments of the present disclosure, the cloud platform includes an information receiving module and a cloud computer vision module. After receiving the environmental acquisition information, the information receiving module of the cloud platform sends the environmental acquisition information to the cloud computer vision module. The cloud computer vision module performs real-time three-dimensional point cloud reconstruction on the environmental acquisition information so as to reconstruct the environmental acquisition information into a three-dimensional point cloud reconstruction result. The cloud computer vision module performs visual recognition on the reconstructed three-dimensional point cloud reconstruction result so as to recognize an obstacle recognition result corresponding to an obstacle in a real environment. The obstacle recognition result includes obstacle information and confidence information corresponding to the obstacle information. The obstacle information is used for characterizing an attribute parameter corresponding to the obstacle in the real environment, including but not limited to at least one of the following: an obstacle type, an obstacle size, an obstacle position, an obstacle material, etc. Further, the attribute parameter is an obstacle type, an obstacle size and an obstacle position. Specifically, the cloud computer vision module may recognize two-dimensional and three-dimensional bounding boxes corresponding to the obstacle in the real environment, and generate obstacle types and confidence information corresponding to the two-dimensional and three-dimensional bounding boxes by marking. The confidence information is used for evaluating the confidence of obstacle information. It can be understood that the three-dimensional point cloud reconstruction result includes at least one piece of obstacle information, usually a plurality of pieces of obstacle information, and each corresponding to one piece of confidence information. And the confidence information corresponding to different obstacle information may be the same or different.

In step 103 according to the embodiments of the present disclosure, the first preset index is used for evaluating the confidence information. There may be one or more first preset indexes. When the confidence information satisfies the first preset index, map calibration information is generated according to obstacle information corresponding to the confidence information, and the map calibration information is sent to the designated robot. It should be supplemented that the obstacle information corresponding to the confidence information may be a three-dimensional point cloud reconstruction result. Before sending the map calibration information to the designated robot, the cloud platform needs to convert the three-dimensional point cloud reconstruction result corresponding to the obstacle information into the map calibration information. Specifically, the obstacle information may be represented by the three-dimensional point cloud reconstruction result, and the map calibration information is represented by map information corresponding to a map. The map information also includes, but is not limited to, an obstacle type, an obstacle size, an obstacle position, an obstacle material, etc. In this way, the designated robot may directly calibrate the map information by receiving the map calibration information from the cloud platform without arranging a point cloud-related functional module.

Further, the confidence information may be characterized by a confidence value, the corresponding first preset index may be characterized by setting a confidence threshold, and when it is determined that the confidence information satisfies the first preset index, it can be understood that the obstacle information corresponding to the confidence information is trustworthy. The first preset index may be set according to a certain attribute corresponding to the obstacle information, i.e., different obstacle information may have different matched first preset indexes according to the attribute corresponding thereto.

When the designated robot is used for the first time, map information may be created based on the map calibration information. When the designated robot is used subsequently, the map information may be calibrated through the map calibration information. It can be understood that when the map calibration information calibrates the map information, the designated robot compares whether obstacles in the map calibration information and the map information are consistent, and calibrates the map content corresponding to the obstacles in the map information if not. The calibration of the map includes, but is not limited to, deleting and setting an obstacle. For example, if there is obstacle A in the map calibration information and there is no obstacle A in the map information, obstacle A is set in the map information according to the map calibration information corresponding to obstacle A. If there is no obstacle B in the map calibration information and there is obstacle B in the map information, obstacle B is deleted in the map information according to the map calibration information corresponding to obstacle B.

Further, since the actual time consumption of the cloud platform to respectively evaluate each piece of confidence information may be different, the cloud platform may send multiple times of map calibration information to the designated robot, and one or more pieces of obstacle information may correspond to the information sent at each time. The designated robot performs batch calibration on the map information according to the received map calibration information. In this case, when the designated robot performs an operation of deleting obstacles on the map information, it is necessary to perform the operation after receiving all the obstacle information.

In order to facilitate the understanding of the above embodiments, a specific implementation scene is provided below for illustration. In this scene, a robot and a cloud robot control platform located in a real environment are included. The robot is provided with a radar and an RGBD camera. The cloud robot control platform includes a computer vision module.

The method includes:
the first operation: the robot uploading information captured by the radar and the RGBD camera to the cloud computer vision module of the cloud robot control platform (HARI) in real time;
the second operation: the cloud computer vision module performing real-time three-dimensional point cloud reconstruction on the information uploaded by the robot;
the third operation: the cloud computer vision module recognizing an obstacle in a current environment and two-dimensional and three-dimensional bounding boxes from a reconstructed three-dimensional point cloud, and marking the type and confidence of the current obstacle;
the fourth operation: the cloud computer vision module sending a real-time three-dimensional point cloud and recognition result to the cloud robot control platform through a cloud platform; and
the fifth operation: the cloud robot control platform converting the successfully marked obstacle into a format adaptive to map information and sending the format to the robot, so as to instruct the robot to calibrate the map information according to the obstacle of the format adaptive to the map information, thereby obtaining calibrated map information.

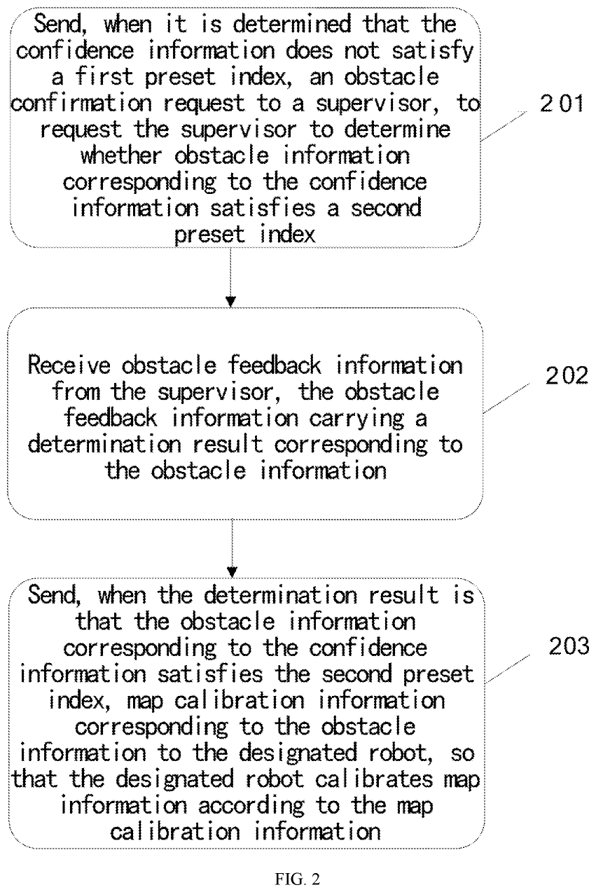

FIG. 2 is a schematic diagram of an implementation flow of judging obstacle information by a supervisor in a point cloud-based map calibration method according to an embodiment of the present disclosure.

Referring to FIG. 2, in an embodiment, the cloud platform is also communicatively connected to a supervisor. The method further includes: step 201, when it is determined that the confidence information does not satisfy a first preset index, sending an obstacle confirmation request to the supervisor, so as to request the supervisor to determine whether obstacle information corresponding to the confidence information satisfies a second preset index; step 202, receiving obstacle feedback information from the supervisor, where the obstacle feedback information carries a determination result corresponding to the obstacle information; and step 203, when the determination result is that the obstacle information corresponding to the confidence information satisfies the second preset index, sending map calibration information corresponding to the obstacle information to the designated robot, so that the designated robot calibrates map information according to the map calibration information.

According to the method, when it is determined that a confidence value corresponding to the confidence information does not satisfy a first index threshold corresponding to the first preset index, it can be considered that the obstacle information corresponding to the confidence information is not trustworthy. In this case, an obstacle confirmation request may be sent to the supervisor. The supervisor may be a management client communicatively connected to the cloud platform. The supervisor may be operated by a worker who judges the obstacle information by the supervisor so as to determine whether the designated robot needs to calibrate the map information according to the obstacle information, and determine the specific operation content of calibrating the map information according to the obstacle information. Specifically, the cloud platform carries several items of the environmental acquisition information, the reconstructed point cloud, the obstacle information, and the confidence information in the obstacle confirmation request and sends the information to the supervisor, so that the supervisor determines whether the obstacle information corresponding to the confidence information satisfies a second preset index according to the above information. In an embodiment, the obstacle confirmation request of the cloud platform only carries the obstacle information and the three-dimensional point cloud reconstruction result corresponding to the obstacle information. The supervisor judges whether the obstacle information satisfies a second preset index according to the three-dimensional point cloud reconstruction result. The second preset index is used for evaluating whether the obstacle information corresponds to an obstacle in a real environment. When the worker of the supervisor determines that the obstacle information corresponds to an obstacle in a real environment, obstacle feedback information is sent to the cloud platform so as to instruct the cloud platform that the obstacle information corresponds to an obstacle in a real environment. It can be understood that when the worker of the supervisor determines that the obstacle information does not correspond to an obstacle in a real environment, the supervisor also sends obstacle feedback information to the cloud platform so as to instruct the cloud platform that the obstacle information does not correspond to an obstacle in a real environment.

In step 202 according to the embodiments of the present disclosure, after the cloud platform receives the obstacle feedback information from the supervisor, a corresponding determination result may be known by analyzing the obstacle feedback information. The determination result includes two results: the obstacle information does not correspond to an obstacle in a real environment and the obstacle information corresponds to an obstacle in a real environment.

In step 203 according to the embodiments of the present disclosure, when the determination result is that the obstacle information corresponding to the confidence information satisfies the second preset index, i.e., the obstacle information corresponds to an obstacle in a real environment, the cloud platform converts the obstacle information into a corresponding map format and sends the format to the designated robot, i.e., sending map calibration information to the designated robot, so that the designated robot calibrates map information according to the map calibration information. It can be understood that when it has been judged whether all the obstacle information satisfies the first preset index and/or the second preset index, i.e., when it has been confirmed whether all the obstacle information corresponds to an obstacle in a real environment, the cloud platform may also send obstacle feedback information to the designated robot so as to notify the designated robot that the obstacle in the real environment has been confirmed. At this time, the designated robot may compare all the map calibration information and map information so as to delete non-corresponding obstacles in the map calibration information in the map information.

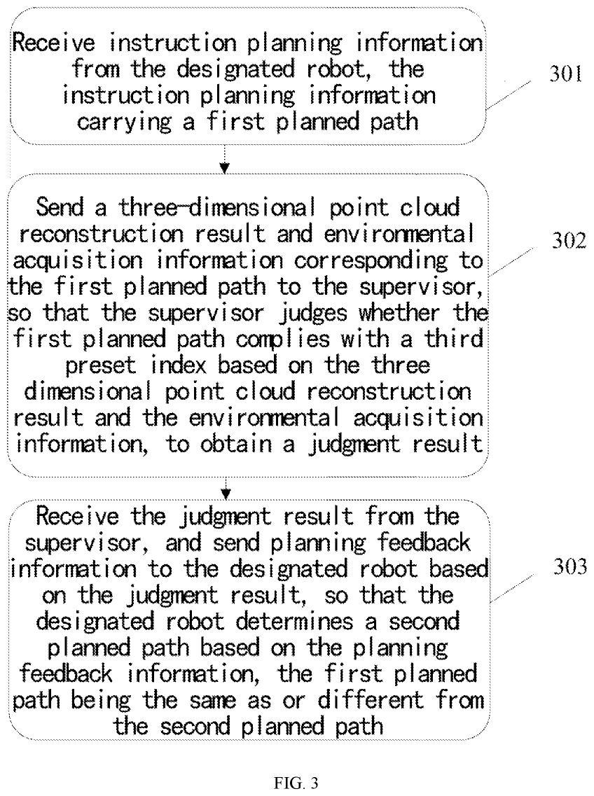

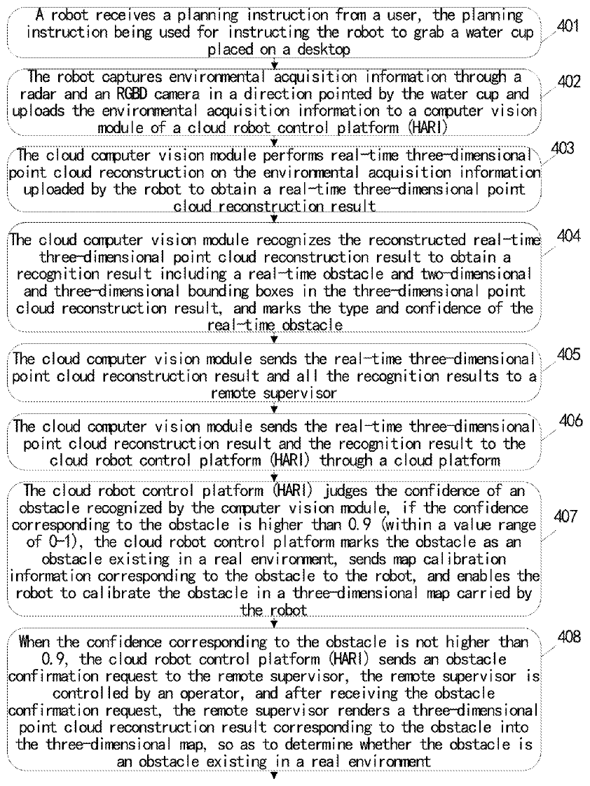

FIG. 3 is a schematic diagram of an implementation flow of calibrating a planned path in a point cloud-based map calibration method according to an embodiment of the present disclosure.

Referring to FIG. 3, in an embodiment, after sending map calibration information corresponding to the obstacle information to the designated robot, the method further includes: step 301, receiving instruction planning information from the designated robot, where the instruction planning information carries a first planned path; step 302, sending a three-dimensional point cloud reconstruction result and environmental acquisition information corresponding to the first planned path to a supervisor, so that the supervisor judges whether the first planned path complies with a third preset index based on the three-dimensional point cloud reconstruction result and the environmental acquisition information, so as to obtain a judgment result; and step 303, receiving the judgment result from the supervisor, and sending planning feedback information to the designated robot based on the judgment result, so that the designated robot determines a second planned path based on the planning feedback information; where the first planned path is the same as or different from the second planned path.

In the embodiments of the present disclosure, a trigger condition for the designated robot to acquire information through a radar and an RGBD camera is that the designated robot obtains a planning instruction for instructing the designated robot to perform path planning. The information acquired by the designated robot through the radar and the RGBD camera is a direction in which a planning destination points in the planning instruction. For example, if the planning instruction is that the designated robot walks to position A in a northwest corner of a room, the designated robot acquires environmental acquisition information towards position A in the northwest corner of the room through the radar and the RGBD camera.

After the designated robot obtains map calibration information from the cloud platform according to the environmental acquisition information and the designated robot calibrates map information according to the map calibration information, the designated robot plans a first planned path corresponding to the planning instruction according to the calibrated map information. After the designated robot completes the first planned path, instruction planning information containing the first planned path is generated, and sent to the cloud platform.

After receiving the instruction planning information, the cloud platform may analyze the instruction planning information to determine whether the first planned path can be used for the designated robot to complete an operation corresponding to the planning instruction. It should be noted that the first planned path includes a walking path for characterizing a movement path of the designated robot within a designated area, and an operation path for characterizing a joint movement path of the robot when performing the operation corresponding to the planning instruction, etc. The first planned path is sent to the cloud platform in the form of a map.

In step 302 according to the embodiments of the present disclosure, the cloud platform sends a three-dimensional point cloud reconstruction result and environmental acquisition information corresponding to the first planned path to a supervisor, so that the supervisor judges whether the first planned path complies with a third preset index based on the three-dimensional point cloud reconstruction result and the environmental acquisition information, so as to obtain a judgment result. The third preset index is used for characterizing whether the three-dimensional point cloud reconstruction result and the environmental acquisition information corresponding to the first planned path are consistent in terms of, at least, size and position. After generating a corresponding judgment result, the supervisor sends the judgment result to the cloud platform.

In step 303 according to the embodiments of the present disclosure, the cloud platform receives the judgment result from the supervisor, and the judgment result may be a judgment result characterizing that the three-dimensional point cloud reconstruction result and the environmental acquisition information corresponding to the first planned path are consistent, or a judgment result characterizing that the three-dimensional point cloud reconstruction result and the environmental acquisition information corresponding to the first planned path are inconsistent.

When the judgment result is that the three-dimensional point cloud reconstruction result and the environmental acquisition information corresponding to the first planned path are consistent, the cloud platform sends planning feedback information to the designated robot, so as to instruct the designated robot to determine the first planned path as a second planned path and perform a designated operation according to the second planned path. In this case, the first planned path is the same as the second planned path.

When the judgment result is that the three-dimensional point cloud reconstruction result and the environmental acquisition information corresponding to the first planned path are inconsistent, the judgment result of the supervisor also carries path adjustment information generated based on a point cloud, and the cloud platform converts the path adjustment information generated based on the point cloud into path adjustment information generated based on a map, and sends planning feedback information to the designated robot. In this case, the path adjustment information generated based on the map is carried in the planning feedback information, so as to instruct the designated robot to adjust the first planned path according to the path adjustment information generated based on the map to obtain a second planned path, and perform a designated operation according to the second planned path. In this case, the first planned path is different from the second planned path. The path adjustment information may be adjustment of a path or adjustment of an obstacle. In the method, the path adjustment information is adjustment of an obstacle.

Another aspect of the embodiments of the present disclosure provides a point cloud-based map calibration method. The method is applied to a robot communicatively connected to a cloud platform. The method includes: firstly, sending environmental acquisition information to the cloud platform, so that the cloud platform performs three-dimensional point cloud reconstruction on the environmental acquisition information, performs obstacle recognition on a three-dimensional point cloud reconstruction result, and obtains an obstacle recognition result; then, the obstacle recognition result including obstacle information and confidence information corresponding to the obstacle information; then, receiving map calibration information from the cloud platform, where the map calibration information corresponding to the obstacle information in which the confidence information satisfies a first preset index; and finally, calibrating map information according to the map calibration information to obtain calibrated map information.

The calibration method provided by the embodiments of the present disclosure is used for obtaining obstacle information and confidence information in a real environment according to three-dimensional point cloud reconstruction, and calibrating map information of a robot according to the obstacle information when the confidence information satisfies a first preset index, so that the robot may better integrate and calibrate obstacles in the real environment and the map information, thereby avoiding colliding with the obstacles in the real environment when the robot navigates or performs other operations according to the map information, reducing a risk factor of robot action and improving the safety of the robot action.

Specifically, the cloud platform according to the embodiments of the present disclosure may establish a communication connection with a plurality of robots. Each robot has a corresponding identity, and the identities of different robots are different, so that the cloud platform may distinguish the plurality of robots. The robot acquires environmental acquisition information corresponding to a real environment through a radar and/or a camera. The environmental acquisition information may be in the form of information directly acquired by the radar and/or the camera, such as a picture and a radar image, i.e., the robot does not perform format conversion on the environmental acquisition information. The cloud platform obtains environmental acquisition information from a robot through communication transmission.

The cloud platform sends the environmental acquisition information to the cloud computer vision module. The cloud computer vision module performs real-time three-dimensional point cloud reconstruction on the environmental acquisition information so as to reconstruct the environmental acquisition information into a three-dimensional point cloud. The cloud computer vision module performs visual recognition on the reconstructed three-dimensional point cloud so as to recognize an obstacle recognition result corresponding to an obstacle in a real environment. The obstacle recognition result includes obstacle information and confidence information corresponding to the obstacle information. The obstacle information is used for characterizing an attribute parameter corresponding to the obstacle in the real environment, including but not limited to at least one of the following: an obstacle type, an obstacle size, an obstacle position, an obstacle material, etc. Further, the attribute parameter is an obstacle type, an obstacle size and an obstacle position. Specifically, the cloud computer vision module may recognize two-dimensional and three-dimensional bounding boxes corresponding to the obstacle in the real environment, and generate obstacle types and confidence information corresponding to the two-dimensional and three-dimensional bounding boxes by marking. The confidence information is used for evaluating the confidence of obstacle information. It can be understood that the reconstructed three-dimensional point cloud includes at least one piece of obstacle information, and usually a plurality of pieces of obstacle information each corresponding to one piece of confidence information.

The first preset index is used for evaluating each piece of confidence information respectively, and when any one of the confidence information satisfies the first preset index, obstacle information corresponding to the confidence information is sent to the robot. It should be supplemented that the obstacle information corresponding to the confidence may be a point cloud, and before the cloud platform sends the obstacle information corresponding to the confidence to the robot, the point cloud corresponding to the obstacle information needs to be converted into map information including but not limited to an obstacle type, an obstacle size, an obstacle position, an obstacle material, etc. In this way, the robot may calibrate the map information by receiving the map calibration information from the cloud platform without arranging a point cloud-related functional module. Further, the confidence information may be characterized by a confidence value, the corresponding first preset index may be characterized by setting a confidence threshold, and when it is determined that the confidence information satisfies the first preset index, it can be understood that the obstacle information corresponding to the confidence information is trustworthy. Furthermore, the first preset index may be set according to the type in the obstacle information, i.e., different obstacle types may correspond to different first preset indexes. It should be further supplemented that map information may be created based on the obstacle information from the cloud platform when the robot is used for the first time and the map information may be calibrated based on the map calibration information from the cloud platform when the robot is used subsequently. It can be understood that when the map information is calibrated based on the map calibration information from the cloud platform, the robot compares whether obstacles in the map calibration information and the map information are consistent, and calibrates the map information corresponding to the map calibration information if not. The calibration of the map includes, but is not limited to, deleting and setting an obstacle. For example, if there is obstacle A in the map calibration information and there is no obstacle A in the map information, obstacle A is set in the map information according to the map calibration information corresponding to obstacle A. If there is no obstacle B in the map calibration information and there is obstacle B in the map information, obstacle B is deleted in the map information according to the map calibration information corresponding to obstacle B. Further, since the actual time consumption of the cloud platform to respectively evaluate each piece of confidence information may be different, the cloud platform may send multiple times of map calibration information to the robot, and one or more pieces of obstacle information may be sent in correspondence to each of the map calibration information. The robot performs batch calibration on the map information according to the received map calibration information. In this case, when the robot performs an operation of deleting obstacles on the map information, it is necessary to perform the operation after receiving all the map calibration information.

In an embodiment, before sending environmental acquisition information to the cloud platform, the method further includes; firstly, obtaining a planning instruction for instructing to perform path planning on the map information according to a designated operation; and then, acquiring information based on the planning instruction to obtain environmental acquisition information.

In the embodiments of the present disclosure, a trigger condition for the robot to acquire information through a radar and an RGBD camera is that the robot obtains a planning instruction for instructing the robot to perform path planning. The information acquired by the robot through the radar and the RGBD camera is a direction in which a planning destination points in the planning instruction. For example, if the planning instruction is that the robot walks to position A in a northwest corner of a room, the robot acquires environmental acquisition information towards position A in the northwest corner of the room through the radar and the RGBD camera.

In an embodiment, after calibrating map information according to the map calibration information, the method further includes: firstly, performing path planning on the designated operation on the calibrated map information to obtain a first planned path; then, sending the first planned path to the cloud platform so as to instruct the cloud platform to judge whether the first planned path complies with a third preset index through a supervisor, so as to obtain a judgment result; and then, receiving planning feedback information corresponding to the judgment result from the cloud platform, and determining a second planned path based on the planning feedback information, where the first planned path is the same as or different from the second planned path.

After the robot obtains map calibration information from the cloud platform according to the environmental acquisition information, the robot calibrates map information according to the map calibration information. The designated robot plans a first planned path corresponding to the planning instruction according to the calibrated map information. After the robot completes the first planned path, instruction planning information containing the first planned path is generated, and sent to the cloud platform. After receiving the instruction planning information, the cloud platform may analyze the instruction planning information to determine whether the first planned path may be used for the robot to complete an operation corresponding to the planning instruction. It should be noted that the first planned path includes a walking path for characterizing a movement path of the robot within a designated area, and an operation path for characterizing a joint movement path of the robot when performing the operation corresponding to the planning instruction, etc.

After receiving the instruction planning information, the cloud platform sends a three-dimensional point cloud reconstruction result and environmental acquisition information corresponding to the first planned path to a supervisor, so that the supervisor judges whether the first planned path complies with a third preset index based on the three-dimensional point cloud reconstruction result and the environmental acquisition information, so as to obtain a judgment result. The third preset index is used for characterizing whether the three-dimensional point cloud reconstruction result and the environmental acquisition information corresponding to the first planned path are consistent. After generating a corresponding judgment result, the supervisor sends the judgment result to the cloud platform.

The cloud platform receives the judgment result from the supervisor, and the judgment result may be a judgment result characterizing that the three-dimensional point cloud reconstruction result and the environmental acquisition information corresponding to the first planned path are consistent, or a judgment result characterizing that the three-dimensional point cloud reconstruction result and the environmental acquisition information corresponding to the first planned path are inconsistent. When the judgment result is that the three-dimensional point cloud reconstruction result and the environmental acquisition information corresponding to the first planned path are consistent, the cloud platform sends planning feedback information to the robot, so as to instruct the robot to determine the first planned path as a second planned path and perform a designated operation according to the second planned path. In this case, the first planned path is the same as the second planned path.

When the judgment result is that the three-dimensional point cloud reconstruction result and the environmental acquisition information corresponding to the first planned path are inconsistent, the judgment result of the supervisor also carries path adjustment information generated based on a point cloud, and the cloud platform converts the path adjustment information generated based on the point cloud into path adjustment information generated based on a map, and sends planning feedback information to the robot. In this case, the path adjustment information generated based on the map is carried in the planning feedback information, so as to instruct the robot to adjust the first planned path according to the path adjustment information generated based on the map to obtain a second planned path, and perform a designated operation according to the second planned path. In this case, the first planned path is different from the second planned path. The path adjustment information may be adjustment of a path or adjustment of an obstacle. In the method, the path adjustment information is adjustment of an obstacle.

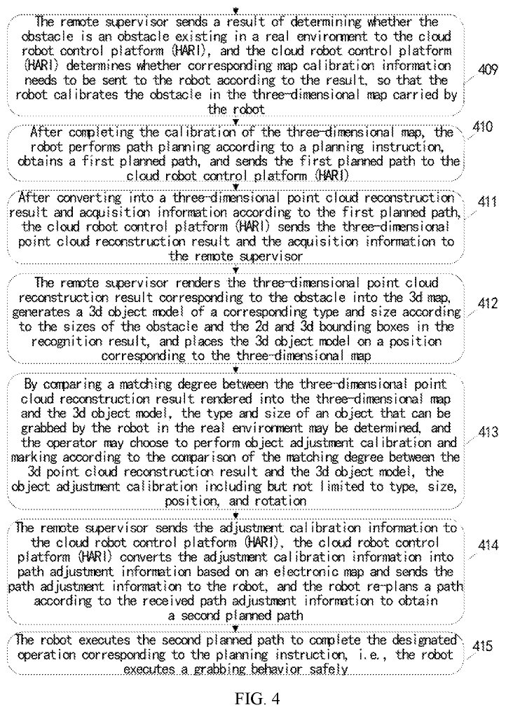

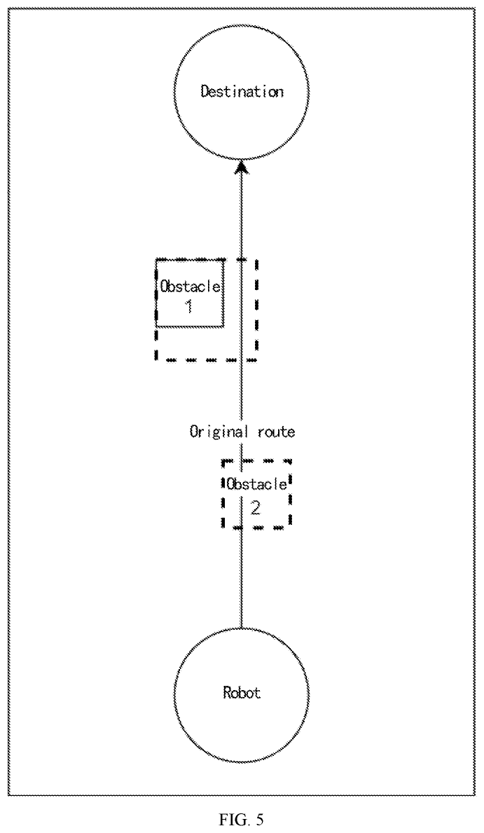

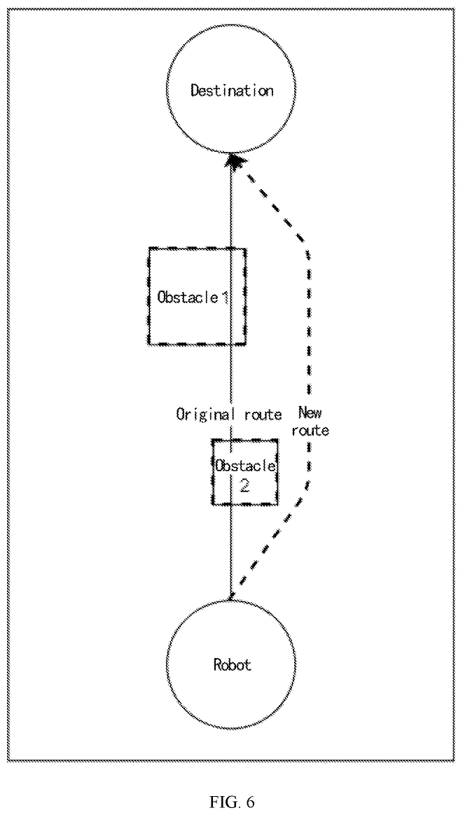

FIG. 4 is a schematic diagram of a scene implementation flow of a point cloud-based map calibration method according to an embodiment of the present disclosure; FIG. 5 is a schematic scene diagram of a point cloud-based map calibration method according to an embodiment of the present disclosure; and FIG. 6 is a diagram of a scene effect after executing a point cloud-based map calibration method according to an embodiment of the present disclosure.

Referring to FIGS. 4, 5 and 6, in order to facilitate an overall understanding of the above embodiments, a specific implementation scene is provided below that includes a robot and a cloud platform. In this scene, the map calibration method includes:
step 401, the robot receiving a planning instruction from a user, where the planning instruction is used for instructing the robot to grab a water cup placed on a desktop;
step 402, the robot capturing environmental acquisition information through a radar and an RGBD camera in a direction pointed by the water cup and uploading the environmental acquisition information to a computer vision module of a cloud robot control platform (HARI);
step 403, the cloud computer vision module performing real-time three-dimensional point cloud reconstruction on the environmental acquisition information uploaded by the robot to obtain a real-time three-dimensional point cloud reconstruction result;
step 404, the cloud computer vision module recognizing the reconstructed real-time three-dimensional point cloud reconstruction result to obtain a recognition result including a real-time obstacle and two-dimensional and three-dimensional bounding boxes in the three-dimensional point cloud reconstruction result, and marking the type and confidence of the real-time obstacle;
step 405, the cloud computer vision module sending the real-time three-dimensional point cloud reconstruction result and all the recognition results to a remote supervisor;
step 406, the cloud computer vision module sending the real-time three-dimensional point cloud reconstruction result and the recognition result to the HARI through the cloud platform;
step 407, the HARI judging the confidence of an obstacle recognized by the computer vision module; if the confidence corresponding to the obstacle is higher than 0.9 (within a value range of 0-1), the cloud robot control platform marking the obstacle as an obstacle existing in a real environment, and sending map calibration information corresponding to the obstacle to the robot, to enable the robot to calibrate the obstacle in a three-dimensional map carried by the robot;
step 408, when the confidence corresponding to the obstacle is not higher than 0.9, the HARI sending an obstacle confirmation request to the remote supervisor, where the remote supervisor is controlled by an operator, and after receiving the obstacle confirmation request, the remote supervisor rendering a three-dimensional point cloud reconstruction result corresponding to the obstacle into the three-dimensional map, so as to determine whether the obstacle is an obstacle existing in a real environment;
step 409, the remote supervisor sending a result of determining whether the obstacle is an obstacle existing in a real environment to the HARI, and the HARI determining whether corresponding map calibration information needs to be sent to the robot according to the result, so that the robot calibrates the obstacle in the three-dimensional map carried by the robot;
step 410, after completing the calibration of the three-dimensional map, the robot performing path planning according to a planning instruction, obtaining a first planned path, and sending the first planned path to the HARI;
step 411, after converting into a three-dimensional point cloud reconstruction result and acquisition information according to the first planned path, the HARI sending the three-dimensional point cloud reconstruction result and the acquisition information to the remote supervisor;
step 412, the remote supervisor rendering the three-dimensional point cloud reconstruction result corresponding to the obstacle into the three-dimensional map, generating a 3d object model of a corresponding type and size according to the sizes of the obstacle and the two-dimensional and three-dimensional bounding boxes in the recognition result, and placing the 3d object model on a position corresponding to the three-dimensional map;
step 413, by comparing a matching degree between the three-dimensional point cloud reconstruction result rendered into the three-dimensional map and the 3d object model, the type and size of an object that can be grabbed by the robot in the real environment may be determined, and the operator may choose to perform object adjustment calibration and marking according to the comparison of the matching degree between the three-dimensional point cloud reconstruction result and the 3d object model, the object adjustment calibration including but not limited to type, size, position, and rotation. For example, it is found that cup 1 is not recognized and a recognized size of cup 2 does not correspond to a real size, so that the hands of the robot may collide with cup 1 while grabbing cup 2, thereby causing a safety risk. Therefore, the operator adds cup 1 in a virtual environment and adjusts the size of cup 2 in the virtual environment so that the virtual and real environment calibrations are consistent through a point cloud;
step 414, the remote supervisor sending the adjustment calibration information to the HARI, the HARI converting the adjustment calibration information into path adjustment information based on an electronic map and sending the path adjustment information to the robot, the robot re-planning a path according to the received path adjustment information to obtain a second planned path so as to guide subsequent navigation, and when the robot grabs cup 2, the obstacle avoidance motion planning of cup 1 will be considered; and
step 415, the robot executing the second planned path to complete the designated operation corresponding to the planning instruction, i.e., the robot executes a grabbing behavior safely.

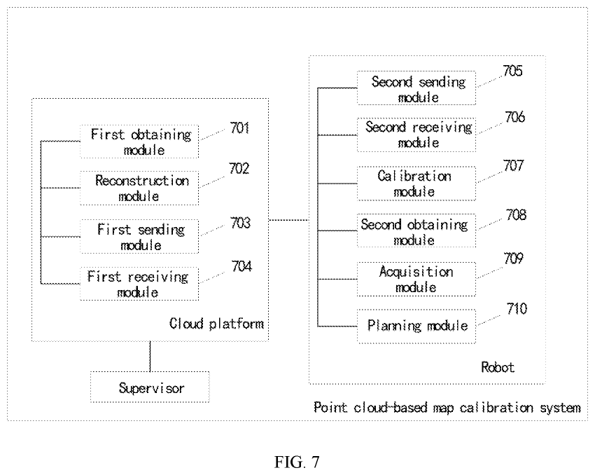

FIG. 7 is a schematic diagram of an implementation module of a point cloud-based map calibration system according to an embodiment of the present disclosure.

Referring to FIG. 7, another aspect of the embodiments of the present disclosure provides a cloud platform communicatively connected to a designated robot. The cloud platform includes: a first obtaining module 701, configured to obtain environmental acquisition information from the designated robot; a reconstruction module 702, configured to perform three-dimensional point cloud reconstruction on the environmental acquisition information, perform obstacle recognition on a three-dimensional point cloud reconstruction result, and obtain an obstacle recognition result including obstacle information and confidence information corresponding to the obstacle information; and a first sending module 703, configured to send, when it is determined that the confidence information satisfies a first preset index, map calibration information corresponding to the obstacle information to the designated robot, so that the designated robot calibrates map information according to the map calibration information.

In an embodiment, the cloud platform is also communicatively connected to a supervisor, and further includes a first receiving module 704. The first sending module 703, is further configured to send, when it is determined that the confidence information does not satisfy a first preset index, an obstacle confirmation request to the supervisor, so as to request the supervisor to determine whether obstacle information corresponding to the confidence information satisfies a second preset index. The first receiving module 704 is configured to receive obstacle feedback information from the supervisor, the obstacle feedback information carrying a determination result corresponding to the obstacle information. The first sending module 703 is further configured to send, when the determination result is that the obstacle information corresponding to the confidence information satisfies the second preset index, map calibration information corresponding to the obstacle information to the designated robot, so that the designated robot calibrates map information according to the map calibration information.

In an embodiment, the first receiving module 704 is further configured to receive instruction planning information from the designated robot, where the instruction planning information carries a first planned path. The first sending module 703 is further configured to send a three-dimensional point cloud reconstruction result and environmental acquisition information corresponding to the first planned path to a supervisor, so that the supervisor judges whether the first planned path complies with a third preset index based on the three-dimensional point cloud reconstruction result and the environmental acquisition information, so as to obtain a judgment result. The first receiving module 704 is further configured to receive the judgment result from the supervisor, and send planning feedback information to the designated robot based on the judgment result, so that the designated robot determines a second planned path based on the planning feedback information. The first planned path is the same as or different from the second planned path.

Another aspect of the embodiments of the present disclosure provides a robot communicatively connected to a cloud platform. The robot includes: a second sending module 705, configured to send environmental acquisition information to the cloud platform, so that the cloud platform performs three-dimensional point cloud reconstruction on the environmental acquisition information, performs obstacle recognition on a three-dimensional point cloud reconstruction result, and obtains an obstacle recognition result including obstacle information and confidence information corresponding to the obstacle information; and a second receiving module 706, configured to receive map calibration information from the cloud platform, the map calibration information corresponding to the obstacle information in which the confidence information satisfies a first preset index; and a calibration module 707, configured to calibrate map information according to the map calibration information to obtain calibrated map information.

In an embodiment, the robot further includes: a second obtaining module 708, configured to obtain a planning instruction for instructing to perform path planning on the map information according to a designated operation; and an acquisition module 709, configured to acquire information based on the planning instruction to obtain environmental acquisition information.

In an embodiment, the robot further includes: a planning module 710, configured to perform path planning on the designated operation on the calibrated map information to obtain a first planned path. The second sending module 705 is further configured to send the first planned path to the cloud platform so as to instruct the cloud platform to judge whether the first planned path complies with a third preset index through a supervisor, so as to obtain a judgment result. The second receiving module 706 is further configured to receive planning feedback information corresponding to the judgment result from the cloud platform, and determines a second planned path based on the planning feedback information. The first planned path is the same as or different from the second planned path.

Another aspect of the embodiments of the present disclosure provides a point cloud-based map calibration system including a cloud platform and a designated robot. The cloud platform is communicatively connected to the designated robot. The cloud platform includes: a first obtaining module, configured to obtain environmental acquisition information from the designated robot; a reconstruction module, configured to perform three-dimensional point cloud reconstruction on the environmental acquisition information, perform obstacle recognition on a three-dimensional point cloud reconstruction result, and obtain an obstacle recognition result including obstacle information and confidence information corresponding to the obstacle information; and a first sending module, configured to send, when it is determined that the confidence information satisfies a first preset index, map calibration information corresponding to the obstacle information to the designated robot, so that the designated robot calibrates map information according to the map calibration information.

In the descriptions of this description, descriptions with reference to the terms “one embodiment”, “some embodiments”, “examples”, “specific examples”, or “some examples” etc. mean that specific features, structures, materials, or characteristics described in conjunction with the embodiment or example are included in at least one embodiment or example of the present disclosure. Furthermore, the specific features, structures, materials, or characteristics described may be combined in a suitable manner in any one or more embodiments or examples. In addition, without contradicting each other, a person skilled in the art may integrate and combine different embodiments or examples and features of different embodiments or examples described in this description.

In addition, terms “first” and “second” are used for descriptive purposes only and are not to be construed as indicating or implying relative importance or implicitly indicating the number of technical features indicated. Thus, a feature defined as “first” or “second” may explicitly or implicitly include at least one such feature. In the descriptions of the present disclosure, the meaning of “a plurality” is two or more, unless specifically and specifically limited otherwise.

The above are only the specific embodiments of the present disclosure, but the protection scope of the present disclosure is not limited thereto. Any person skilled in the art can easily conceive of changes or substitutions within the technical scope disclosed in the present disclosure, which should be included within the protection scope of the present disclosure. Therefore, the protection scope of the present disclosure should be subject to the protection scope of the claims.

What is claimed is:

1. A point cloud-based map calibration method, being applied to a cloud platform communicatively connected to a designated robot, comprising:
obtaining environmental acquisition information from the designated robot;
performing three-dimensional point cloud reconstruction on the environmental acquisition information, performing obstacle recognition on a three-dimensional point cloud reconstruction result, and obtaining an obstacle recognition result comprising obstacle information and confidence information corresponding to the obstacle information; and
when it is determined that the confidence information satisfies a first preset index, sending map calibration information corresponding to the obstacle information to the designated robot, so that the designated robot calibrates map information according to the map calibration information.

2. The method according to claim 1, wherein the cloud platform is also communicatively connected to a supervisor, the method further comprising:
when it is determined that the confidence information does not satisfy a first preset index, sending an obstacle confirmation request to the supervisor, so as to request the supervisor to determine whether obstacle information corresponding to the confidence information satisfies a second preset index;
receiving obstacle feedback information from the supervisor, wherein the obstacle feedback information carries a determination result corresponding to the obstacle information; and
when the determination result is that the obstacle information corresponding to the confidence information satisfies the second preset index, sending map calibration information corresponding to the obstacle information to the designated robot, so that the designated robot calibrates map information according to the map calibration information.

3. The method according to claim 1, wherein after sending map calibration information corresponding to the obstacle information to the designated robot, the method further comprises:
receiving instruction planning information from the designated robot, wherein the instruction planning information carries a first planned path;
sending a three-dimensional point cloud reconstruction result and environmental acquisition information corresponding to the first planned path to a supervisor, so that the supervisor judges whether the first planned path complies with a third preset index based on the three-dimensional point cloud reconstruction result and the environmental acquisition information, so as to obtain a judgment result; and
receiving the judgment result from the supervisor, and sending planning feedback information to the designated robot based on the judgment result, so that the designated robot determines a second planned path based on the planning feedback information,
wherein the first planned path is the same as or different from the second planned path.

4. A point cloud-based map calibration method, being applied to a robot communicatively connected to a cloud platform, comprising:
sending environmental acquisition information to the cloud platform, so that the cloud platform performs three-dimensional point cloud reconstruction on the environmental acquisition information, performs obstacle recognition on a three-dimensional point cloud reconstruction result, and obtains an obstacle recognition result comprising obstacle information and confidence information corresponding to the obstacle information;
receiving map calibration information from the cloud platform, the map calibration information corresponding to the obstacle information in which the confidence information satisfies a first preset index; and
calibrating map information according to the map calibration information.

5. The method according to claim 4, wherein before sending environmental acquisition information to the cloud platform, the method further comprises:
obtaining a planning instruction for instructing to perform path planning on the map information according to a designated operation; and
acquiring information based on the planning instruction to obtain environmental acquisition information.

6. The method according to claim 5, wherein after calibrating map information according to the map calibration information, the method further comprises:
performing path planning on the designated operation on the calibrated map information to obtain a first planned path;
sending the first planned path to the cloud platform so as to instruct the cloud platform to judge whether the first planned path complies with a third preset index through a supervisor, so as to obtain a judgment result; and
receiving planning feedback information corresponding to the judgment result from the cloud platform, and determining a second planned path based on the planning feedback information,
wherein the first planned path is the same as or different from the second planned path.

7. A cloud platform, being communicatively connected to a designated robot, comprising:
an obtaining module, configured to obtain environmental acquisition information from the designated robot;
a reconstruction module, configured to perform three-dimensional point cloud reconstruction on the environmental acquisition information, perform obstacle recognition on a three-dimensional point cloud reconstruction result, and obtain an obstacle recognition result comprising obstacle information and confidence information corresponding to the obstacle information; and
a first sending module, configured to send, when it is determined that the confidence information satisfies a first preset index, map calibration information corresponding to the obstacle information to the designated robot, so that the designated robot calibrates map information according to the map calibration information.

8. The cloud platform according to claim 7, being also communicatively connected to a supervisor, further comprising: a first receiving module, wherein
the first sending module is further configured to send, when it is determined that the confidence information does not satisfy a first preset index, an obstacle confirmation request to the supervisor, so as to request the supervisor to determine whether obstacle information corresponding to the confidence information satisfies a second preset index;
the first receiving module is configured to receive obstacle feedback information from the supervisor, the obstacle feedback information carrying a determination result corresponding to the obstacle information; and
the first sending module is further configured to send, when the determination result is that the obstacle information corresponding to the confidence information satisfies the second preset index, map calibration information corresponding to the obstacle information to the designated robot, so that the designated robot calibrates map information according to the map calibration information.

9. A robot, being communicatively connected to a cloud platform, comprising:
a second sending module, configured to send environmental acquisition information to the cloud platform, so that the cloud platform performs three-dimensional point cloud reconstruction on the environmental acquisition information, performs obstacle recognition on a three-dimensional point cloud reconstruction result, and obtains an obstacle recognition result comprising obstacle information and confidence information corresponding to the obstacle information;
a second receiving module, configured to receive map calibration information from the cloud platform, the map calibration information corresponding to the obstacle information in which the confidence information satisfies a first preset index; and
a calibration module, configured to calibrate map information according to the map calibration information to obtain calibrated map information.

10. A point cloud-based map calibration system, comprising a cloud platform and a designated robot, the cloud platform being communicatively connected to the designated robot, the cloud platform comprising:
an obtaining module, configured to obtain environmental acquisition information from the designated robot;
a reconstruction module, configured to perform three-dimensional point cloud reconstruction on the environmental acquisition information, perform obstacle recognition on a three-dimensional point cloud reconstruction result, and obtain an obstacle recognition result comprising obstacle information and confidence information corresponding to the obstacle information; and
a first sending module, configured to send, when it is determined that the confidence information satisfies a first preset index, map calibration information corresponding to the obstacle information to the designated robot, so that the designated robot calibrates map information according to the map calibration information.
